(19) United States
(12) Patent Application Publication
(10) Pub. No.: US 2014/0025548 A1
(43) Pub. Date: Jan. 23, 2014

(54) AUTOMATED ANOMALY DETECTION FOR REAL ESTATE TRANSACTIONS

(71) Applicant: Dianna Lee Serio, Irvine, CA (US)

(72) Inventor: Dianna Lee Serio, Irvine, CA (US)

(73) Assignee: CORELOGIC SOLUTIONS, LLC, Santa Ana, CA (US)

(21) Appl. No.: 13/551,499

(22) Filed: Jul. 17, 2012

(51) Int. Cl. G06Q 40/02

(52) U.S. Cl. CPC G06Q 40/02
USPC 705/35

(57) ABSTRACT

Processes are disclosed for assessing a risk of fraud associated with a property, such as for specific transactions associated with the property. For instance, processes are described for assessing a risk of fraud associated with publicly recorded documents describing transactions associated with real estate properties. In one embodiment, a process accesses appropriate data (e.g., aggregated loan data, aggregated property data such as property transaction history data, etc.) and processes the data to determine whether one or more triggering conditions are met. The triggering conditions are indicative of an elevated risk of fraud with respect to a transaction such as a publicly recorded lien release.

### BACKGROUND

1. Technical Field

The present invention relates to computerized analysis for detecting anomalies associated with property transactions. Such anomalies can be indicative of a potential risk of fraud associated with property transactions, such as the recording of a release of a lien on a property. Detected anomalies can also result from data entry mistakes, or may otherwise not necessarily be correlated potential fraud.

2. Description of the Related Art

When entering into real estate transactions, financial institutions, title companies, and other entities involved in the real estate industry often rely on the accuracy of publicly recorded documents. For instance, before granting a loan on a property that will be secured by a lien, a lender or other appropriate entity may rely on a publicly recorded “lien-release”—a document indicating that a previous lien on the property has been removed. However, such documents are fraudulently or erroneously recorded in some cases. For instance, a party might forge a lien-release and record the forged document in the hopes of convincing an unsuspecting party that the property is free of encumbrances.

### SUMMARY

Where publicly recorded documents are not accurate, there is a significant risk of financial loss. As one example scenario, a lender relies on a fraudulent, publicly recorded lien-release in agreeing to finance a loan on a property. But in actuality, the property is secured by an existing lien owned by another lender. In this case, the defrauded lender can incur significant legal and other expenses, and it is likely that the lender will not ultimately recover some or all of the lent funds and other expenses.

To address these and other problems, computer-implemented processes are disclosed for assessing a risk of fraud associated with a property, such as for specific transactions associated with the property. For instance, processes are described for assessing a risk of fraud associated with publicly recorded documents describing transactions associated with real estate properties. One such document is a lien-release, which indicates that a holder of a lien secured by the property has released the lien. Some embodiments can additionally detect inaccuracies associated with a property (e.g., with publicly recorded documents associated with the property), including inaccuracies resulting from data entry errors, for example.

As will be described in further detail, the disclosed processes can maintain and process various types of property-specific data in making the fraud risk determination, or in detecting other, non-fraud indicative anomalies. According to certain aspects, for instance, a process determines fraud risk for a particular transaction based on whether the processing of the property-specific data satisfies any of a pre-determined set of fraud-indicative triggering conditions. In some cases, a process parses a property transaction history to identify patterns correlated to elevated fraud risk. Fraud risk indicators for particular transactions can also be integrated into a displayable transaction history, providing intuitive and readily accessible risk information to lenders and other entities.

### BRIEF DESCRIPTION OF THE DRAWINGS

FIG. 1 illustrates an analytics system that determines fraud risk for transactions associated with a property.

FIG. 2 illustrates a sequence of steps performed by one embodiment of the analytics system of FIG. 1 to assess whether a particular transaction associated with the property has an elevated risk of fraud.

FIG. 3 illustrates a sequence of steps performed by one embodiment of the analytics system of FIG. 1 to determine whether one or more patterns exist in a transaction history associated with a property that indicate an elevated risk of fraud.

FIG. 4 illustrates a sequence of steps performed by one embodiment of the analytics system of FIG. 1 to integrate a fraud risk indicator with a transaction history associated with the property.

FIG. 5 illustrates a user interface providing a property transaction history and that includes an integrated fraud risk indicator for at least one transaction in the transaction history.

### DETAILED DESCRIPTION OF SPECIFIC EMBODIMENTS

Specific, non-limiting embodiments will now be described with reference to the drawings. Nothing in this description is intended to imply that any particular feature, component or step is essential. The inventive subject matter is defined by the claims.

The processes may be incorporated into one or more tools or services that are available via a web site or other interface to lenders, financial institutions, title companies, title agents, attorneys and/or other types of entities. The described processes in some cases preferably use property-related data aggregated from multiple sources and jurisdictions to determine fraud risk. While described for the purposes of simplicity primarily in relation to determining elevated fraud risk, the systems and method described herein can also be used to determine other anomalies associated with a property. These anomalies such as inaccuracies associated with publicly recorded documents, such as those due to data entry error or document creation error, for example.

In one embodiment, a process accesses appropriate data (e.g., aggregated loan data, aggregated property data such as property transaction history data, etc.) and processes the data to determine whether one or more triggering conditions are met. The data may also be processed and compared with existing information to detect and/or correct for inaccuracies, as is described in further detail below. The triggering conditions are indicative of an elevated risk of fraud with respect to the property, such as with one or more publicly recorded or otherwise reported transactions associated with the property. For instance, a loan servicing database including aggregated loan data may be accessed to determine if a loan associated with a purportedly released lien is still active. Or, a trigger condition may exist where an assignment or other transfer of ownership of a mortgage lien has an elevated risk of being fraudulent. For example, a trigger condition may exist where a mortgage lien is assigned to a party that is not included in a pre-determined group of qualified entities, such as a group of pre-qualified financial institutions or other lenders.

Another described process maintains a transaction history associated with a property and/or analyzes the transaction history for a pattern that indicates an elevated risk of fraud associated with the property, or with a particular transaction in the transaction history. For instance, an elevated risk of fraud can exist where a pattern of transactions indicates that the reported encumbrance status of the property is likely to be inaccurate. One example of such a pattern is where a lien is released on a property before another lien on the property is recorded. For instance, a first lien is recorded for a property, and a release of the first lien is recorded without an intervening second lien being recorded between the recording of the first lien and the recording of the release. As used herein, the term “second lien” refers to a newly originated lien that is recorded and takes the place of another lien. Thus, in this case a second lien is not necessarily, but may be, senior to an existing lien that was junior to the lien that was replaced by the newly originated second lien. As described the first lien may be satisfied or otherwise released, and the second lien generally replaces the first lien.

An additional process associates a determined risk of fraud for a lien transaction with a transaction history corresponding to the property. For instance, an indication as to the determined fraud risk can be intuitively incorporated into a web page or other user interface displaying the transaction history. In some configurations, an icon or text indicating a risk of fraud (or lack thereof) is juxtaposed with a description of the corresponding lien transaction. One or more bases for the determined risk of fraud may also be displayed or otherwise associated with the transaction history. For instance, a reason for the fraud determination (e.g., loan still active) may be displayed, such as when the user clicks on or otherwise interacts with the indication of the fraud risk on the user interface.

Certain embodiments described herein utilize date information associated with property transactions in making fraud-risk determinations. Such determinations are described primarily in relation to recordation dates and/or document numbers at which documents describing the respective transactions are publicly recorded. However, instead of or in addition to using recordation dates, such determinations may be based on the dates at which respective transactions occurred or allegedly occurred, e.g., as indicated in the recorded documents, which could be document creation dates, document execution dates, and document signature dates.

In addition, while certain of the inventions described herein are preferably applicable to real estate, certain embodiments can be used in association with other types of properties, such as automobiles or other goods.

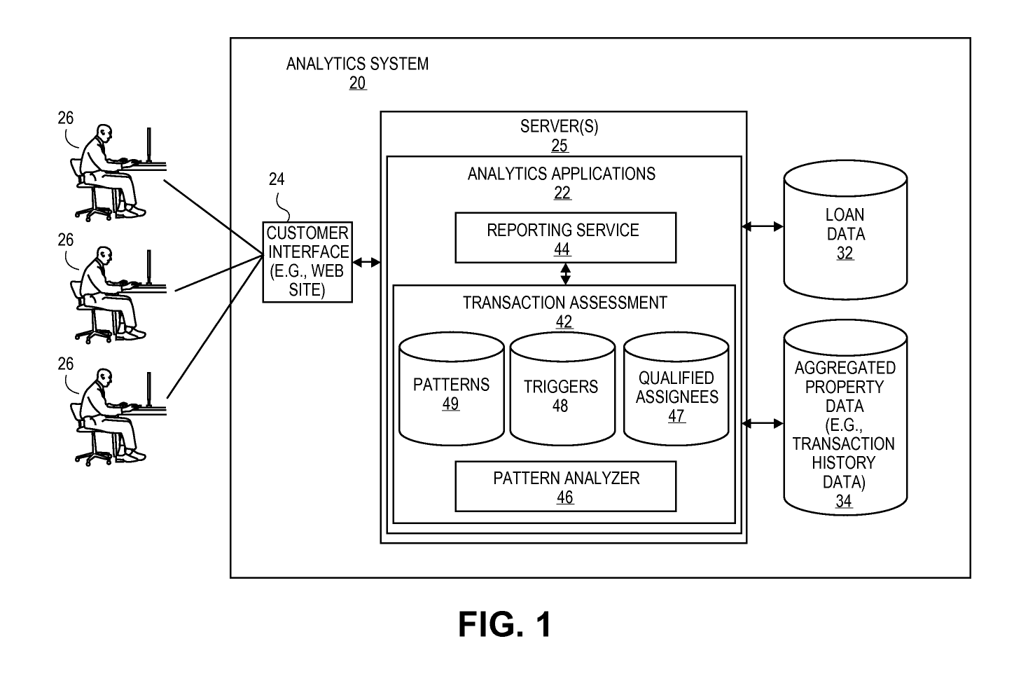

### I. System Overview (FIG. 1)

FIG. 1 illustrates an analytics system 10 according to one embodiment. The system 20 may be provided by a business entity or “analytics provider” that provides various services to its customers for assessing risk levels associated with real estate transactions (e.g., mortgage liens) and other types of transactions. As illustrated, the system 20 includes a set of analytics applications 22 that can be accessible over a network (such as the Internet) via a customer interface 24 or through a batched record request delivered via email or an FTP server. The customer interface 24 may, for example, include a web site, an extranet, a web services interface, and/or any other type of interface that enables customers to remotely access and use the applications via their computing devices 26 (desktop computers, mobile phones, laptops, servers, etc.). Typical customers of the system 20 include mortgage lenders, other types of lenders, mortgage servicers, real estate investors, title companies, and property insurance companies.

As illustrated, the analytics applications 22 use a set of data repositories 32, 34 to perform various types of tasks, including tasks associated with assessing risk associated with purported transactions involving real estate properties (e.g., lien-related transactions). For instance, the applications 22 may perform tasks associated with determining a risk of fraud associated with a recorded document that purports to release a lien on a property. In the illustrated embodiment, these data repositories 32, 34 include a database of loan data 32 (preferably aggregated/contributed from multiple lenders) and a database of aggregated property data 34, which can include public recorder data. Although depicted as separate databases, some of these data collections may be merged into a single database or distributed across multiple distinct databases. Further, additional databases containing other types of information may be maintained and used by the analytics applications 22. As shown in FIG. 1, each analytic application 22 runs on one or more physical servers 25 or other computing devices.

The database of loan data 32 preferably includes aggregated mortgage loan related data provided by lenders of mortgages or other types of loans. The mortgage data can include servicing data, for example. Servicing data can include an indication as to the status of a particular loan (e.g., “active”, “inactive”, “in default”, “settled”, “delinquent”, “in bankruptcy”, etc.). In one embodiment, the loan database 32 includes loan status and/or other information for about 85% of the existing mortgages in the United States. Such a database is maintained by CoreLogic, Inc. Generally, the database 32 in certain embodiments can include any dataset found in a loan application, or any other appropriate information. Some or all of the data can also be generated or manipulated by third parties prior to receipt by the system 20. As just a few examples, the database 32 can include information related to the value of a loan, the appraised value of a property associated with the loan, a delinquency date and/or delinquency duration (e.g., 30, 60, or 90 days) associated with the loan, and the like.

The loan data can also include loan application information. For instance, a consortium of lenders may submit loan application information to the loan database 32. The analytics provider may obtain the loan data in various ways. For example, lenders and other customers of the analytics system 20 may supply such data to the system 20 in the course of using the analytics applications 22. The customers may supply such data according to an agreement under which the analytics provider and system can persistently store the data and re-use it for generating summarized analytics to provide to the same and/or other customers. Such a database is maintained by CoreLogic, Inc. As another example, the analytics provider may obtain such loan data through partnership agreements. As yet another example, the analytics provider may itself be a mortgage lender, in which case the loan data may include data regarding its own loans. Loan data obtained by the analytics provider from lenders is referred to herein as “contributed loan data.”

The aggregated property database 34 depicted in FIG. 1 contains aggregated data collected from public recorder offices in various counties throughout the United States and/or other appropriate sources. This database 34 includes property specific records including ownership information and transaction histories, such as those obtained from recorded land records (grant deeds, trust deeds, mortgages, other liens, etc.). In one embodiment, the analytics provider maintains this database 34 by purchasing or otherwise obtaining public record documents from most or all of the counties in the United States (from the respective public recorders offices), and by converting those documents (or data obtained from such documents) to a standard format. Such a database is maintained by CoreLogic, Inc. The aggregated property database 34 is preferably updated on a daily or near-daily basis so that it closely reflects the current ownership statuses of properties throughout the United States. In one implementation, the database 34 covers 97% of the sales transactions from over 2,535 counties. The data in the loan database 32 and/or property database 34 in some embodiments is advantageously pre-processed to verify and enrich the data for improved usability. For instance, the analytics system 20 may collect and scrub the data to determine its accuracy. Where mistakes are found, the system 20 may discard or correct the data, depending on the circumstances. For instance, the system 20 may cross-check the source data with other related data to check and/or correct misspellings, inconsistencies and the like. As one example, upon receipt of a document associated with a property having a particular mailing address, certain information in the document may be cross-checked with another document in the database 32, 34 associated with that property. If a discrepancy is found, the system 20 flags the received document as possibly being inaccurate and/or corrects any inaccuracies.

Other types of databases can also be included. In some embodiments, instead of or in addition to accessing the aggregated property database 34, the analytics component 22 may directly access property data from one or more public records data sources (not shown).

In another embodiment a public assessor database (not shown) can contain aggregated tax roll data, including land files and assessment information, collected from the public assessor offices in various counties throughout the United States. This data includes, among other items, the mailing addresses of record for contacting home owners, for example to mail property tax bills. Such mailing address data is useful for identifying properties owned by individuals, particularly where such properties are not identifiable from other sources of property ownership data, including Social Security Number based sources. (As used herein, the term “owned” and its variants are not limited to exclusive ownership.) In one embodiment, the analytics provider maintains the database of public assessor data by purchasing or otherwise obtaining public assessor data from most or all counties (public assessor offices) throughout the United States, and by converting this data into a standard format. Such a database is maintained by CoreLogic, Inc. Property-specific records in the public assessor database are preferably linked with corresponding records in the public recorder database 34, such that the two databases collectively form a national real estate database containing both recorder and assessor data.

In another embodiment, a credit bureau database is also included which maintains credit information associated with consumers. The credit bureau database may be accessed to determine credit risk or other financial information associated with individuals involved in real estate transactions (e.g., lien-release transactions). Such information can be used as an input to a fraud risk determination associated with certain transactions, for example.

As further shown in FIG. 1, the analytics applications 22 include a “transaction assessment” application or component 42, which can be a software module. As explained herein, this application or component 42 uses some or all of the data sources described above to assess a risk of fraud associated with a particular property. For instance, the component 42 can determine a risk of fraud associated with reported transactions related to the property (e.g., liens or grant deeds), such as a risk of that publicly recorded lien transactions are fraudulent. This risk assessment can be very useful in making lending decisions or other decisions associated with the property. As one example, before funding a new loan on the property, a mortgage lender may use such information to determine a likelihood that a publicly recorded document describing a lien release is valid.

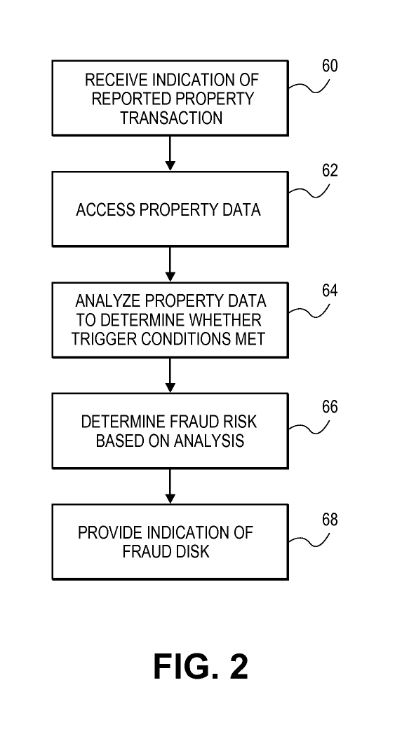

The transaction assessment component 42 can include or have access to a set of triggers 48. The triggers 48 can include a set of one or more pre-determined conditions associated with a reported (e.g., publicly recorded) lien transaction, or other reported property-related transaction. Satisfaction of one or more of the respective trigger conditions 48 indicates an elevated fraud risk associated with transactions related to the property, such as with a publicly recorded document describing a lien release, lien assignment, or other transaction. Triggering conditions 48 can include detecting by the transaction assessment component 42 one or more of the following:
(1) an inconsistency between the status of a loan secured by a lien on a property and a recorded document indicating that the lien has been released, such as where the status of the loan is “active” after the alleged lien release and/or after the recording of the lien release;
(2) the existence of one or more patterns of transactions or transaction types in the property transaction history, where the patterns are correlated to an increased risk of fraud associated with certain transactions;
(3) an assignment of a lien (e.g., a mortgage lien) having an elevated fraud risk, such as an assignment to a non-qualified entity (e.g., a private party or other entity that is included in a pre-approved list of qualified financial institutions and/or other entities); and
(4) that a potential borrower associated with the property has one or more other pending loan applications on file for other properties.
   As used herein, the term “active” in some embodiments refers to a status reported by a loan servicing entity (e.g., the lending bank or servicing company associated with the lending bank). For instance, the loan servicing entity may review its own internally collected data to determine the loan status. As one example, if the property owner is actively making payments on the loan, the servicing entity may report the status as active. The triggering process will be described in further detail herein (e.g., in section II, with respect to FIG. 2).

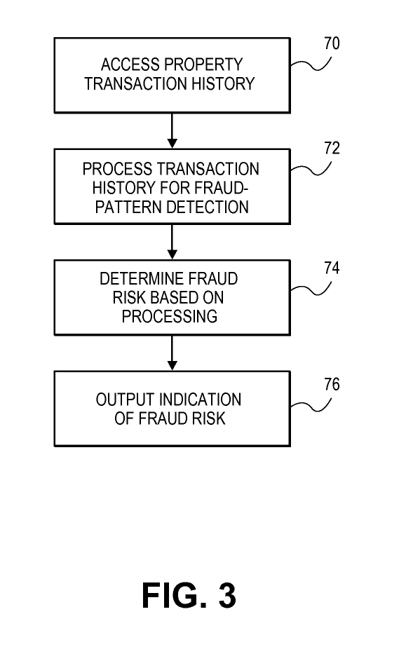

The lien transaction assessment component can include a “pattern analyzer” component 46 configured to analyze property transaction histories (e.g., those obtained from the aggregated property database 34) to determine a risk of fraud associated with reported lien-related or other transactions associated with the property. For example, the pattern analyzer 46 can include or have access to a set 49 of one or more pre-determined sequences of transactions indicative of a relatively high risk of fraud associated with a recorded lien-release or other transaction. In one embodiment, the system generates the pre-determined sequences using correlations in historical data. For instance, the pattern analyzer 46 in such an embodiment may determine common patterns in transaction histories including fraudulent transactions (e.g., fraudulent recordings of lien-releases), and identify those common patterns as being indicative of an elevated risk of fraud. The functionality of the pattern analyzer 46 is discussed in further detail herein, e.g., in section III below, with respect to FIG. 3.

The system 20 can also maintain a list of qualified assignees 47, which can preferably include pre-qualified financial institutions or other approved entities such as repeat players in the real estate financing industry. While shown as part of the assessment component 42, one or more of the triggers 48, patterns 49 and qualified assignees 47 can be stored separately in some embodiments, such as in one or more separate databases. In some embodiments, the users can modify the triggers 48, patterns 49 and/or qualified assignees 47 via the customer interface 24.

The analytics applications 22 also include a “reporting service” application or component 44. This application or component 44 is in communication with the transaction assessment component 42, and reports results received from the assessment component 42 to a customer or other user. Generally, the reporting service 44 communicates risk information generated by the assessment component 42 or other components of the analytics system 20 to the customer(s). For instance, the user can access the reporting component 42 via the customer interface 24.

A subscription-based service may be employed, where the reporting service 44 provides on-going (e.g., scheduled) monitoring and associated reporting to subscribing customers. Reporting can be performed automatically at pre-defined intervals (e.g., daily, weekly, monthly, etc.) or ad-hoc. Moreover, the reporting service 44 can electronically communicate reports via generally any appropriate mechanism, including email, SMS text-message, on-line interface, etc. For instance, the reporting service 44 can proactively send fraud alerts using any of these communication methods.

In some embodiments, the reporting service 44 is event-driven, and automatically generates and sends a report to customer(s) in response to detecting relevant activity associated with a subject property, such as the recording of a document describing a transaction related to a property. For instance, in response to detecting that a lien-release or other transaction has been recorded for a particular property, the assessment component 42 assesses the risk associated with the transaction in any of the manners described herein, and the reporting service 44 generates and forwards to one or more customers a report including the results of the assessment.

Whether at pre-defined intervals or event-driven, the reporting service 44 in some cases sends the report out globally to all of the subscribing customers, or to a group of subscribing customers having an appropriate membership level or plan.

The reporting service 44 in some cases can also send fraud risk reports out in a targeted fashion. For instance, when a event occurs with respect to a particular property, the reporting service 44 may access one or more of the data sources described herein (e.g., one of the databases 32, 34), or some other data source, to determine which customers to send a risk assessment report to. As an example, where a document describing a lien-release is recorded for the property, the reporting service 44 can determine whether the releasing entity is a subscribing customer and, if so, send a report to that customer. The reporting service 44 can also access the loan database 32 to determine whether any subscribing customers own a mortgage on the property, are in receipt of a loan application for the property, or have some other interest in the property, and send reports to those customers.

Moreover, instead of initially sending the risk assessment report, the reporting service 44 in some embodiments sends targeted offers to provide the report to one or more appropriate customers or other entities, where the targeting is performed in any of the above-described manners. Customers can elect to respond to the offer by purchasing or otherwise accessing the report.

The reporting service 44 can also generate reports in response to user requests, such as requests from one or more of the customers via the customer interface 24.

### II. Trigger-Based Assessment of Fraud Risk for Property Transactions (FIG. 2)

FIG. 2 illustrates one embodiment of a process that may be used by the lien analytics system 20 of FIG. 1 to assess and/or report fraud risk associated with a property, such as risk associated with a publicly-recorded (or otherwise reported) lien-related or other type of property transaction. The process can preferably be used for analyzing publicly recorded lien-release transactions, although other transactions can also be analyzed (e.g., grant deeds, trust deeds, mortgages, assignments, applications for loans, etc.).

The process can be responsive to the public recording of particular transactions associated with the property, the public recording of documents describing such transactions, or to the reporting of property transactions in other manners not involving public recordation. In some embodiments, the process can be responsive to other actions, such as user input (e.g., via the user interface 24) requesting a risk assessment associated with a particular property, a particular transaction, or a particular document, or user input requesting a risk assessment associated with a submitted loan application. The process can additionally be responsive to scheduled reporting by the reporting service 44 of risk information to a customer, such as a lender.

In block 60 of FIG. 2, the process in some embodiments receives an indication that a transaction related to the property has been publicly recorded, reported in some other fashion, or is otherwise to be processed by the assessment component 42. The indication can be received in response to a customer request, e.g., using the customer interface 24. The process can receive the indication in a variety of ways. In one embodiment, a document describing an alleged lien-release or other transaction is recorded in a public recorder's office. Certain descriptive information related to the document (e.g., document number, recordation date, document/transaction type, title, buyer/borrower name, seller name, lender name, etc.) is made available to the system 20. The system 20 accesses the data and associates it with a record corresponding to the property in the property database 34. The property database 34 in some embodiments comprises a loan servicing database or “contributed database” including aggregated data collected from multiple banks or other appropriate entities. In some cases, an electronic copy of the recorded document is uploaded to a publicly available location, and is purchased or otherwise accessed by the system 20. The analytics system 20 updates the record corresponding to the subject property in the property database 34 with the document, or with at least some of the document's content.

In one embodiment, the system 20 does not access the document itself initially, and the assessment component 42 instead utilizes the descriptive information mentioned above (e.g., document number, recordation date, etc.) to perform a risk assessment on the transaction described by the document. The risk assessment can be performed using any of the techniques described herein. If the risk assessment indicates that there is an elevated risk of fraud associated with the transaction, the system 20 automatically accesses (e.g., purchases) the document, or automatically provides a recommendation to a user that the document should be accessed. As such, the system 20 in this embodiment only accesses the document when there is an elevated risk of fraud. Thus, this approach provides useful fraud risk information while reducing costs associated with unnecessarily purchasing copies of publicly recorded documents where the risk of fraud is relatively low.

Once the database 34 is updated, the process may be notified. Or, in some embodiments, the process polls the aggregated property database 34 for newly reported lien-release transactions, or transactions that are otherwise due for processing.

While block 60 is described with respect to receiving an indication of a transaction described in a publicly recorded document, the process at block 60 can receive an indication of other types of transactions. For instance, the process may access the loan database 32 to determine that a prospective borrower has submitted a loan application on one or more properties. In some cases, receives an indication that an interest in the property has been assigned, such as a mortgage. Such an assignment may or may not be publicly recorded.

As mentioned, in some cases, the indication is received in response to customer input. For instance, a customer may use the customer interface 24 to request validation of one or more reported transactions (e.g., lien-releases) for a particular piece of property.

At block 62, the process accesses data associated with the indicated transaction. For instance, depending on the situation, the process can access any of the loan database 32, the aggregated property database 34, another appropriate data source, or a combination thereof. As an example, the process may obtain record(s) from the loan database 32 corresponding to one or more loans that have been granted on the subject property.

The process can also obtain a transaction history associated with the property from the aggregated property database 34. The transaction history can include a sequential listing of transactions associated with the property, including entries for one or more recorded documents associated with the property (e.g., grant deeds, trust deeds, lien-releases, mortgages, etc.).

In some cases, the process accesses the aggregated property database or another source to determine information about an assignment of an interest in the property, which can include information regarding the parties involved in the transaction or other information.

While described as separate blocks, blocks 60 and 62 can be combined, or occur generally together in some cases. For instance, the process may obtain the data related to the transaction (block 62) along with the received indication of the transaction (block 60).

At block 64, the process analyzes the accessed property data to determine whether one or more trigger conditions 48 are met that are indicative of an elevated fraud risk.

As indicated previously, one example trigger condition 48 is inconsistency between information associated with a loan secured by a lien on a property and a recorded document indicating that the lien has been released. As one example case, the process at block 60 receives an indication that a document describing a lien release has been recorded and, at block 62 the process accesses the loan database 32 to obtain a current status of a loan that is secured by the lien (e.g., “active”, “inactive”, “in default”, “paid in full”, “settled”, etc.). Because any loan secured by the lien would typically be settled in conjunction with the release of the lien, if the loan status indicates that the loan is still active, the process determines that an inconsistency exists, and that a trigger condition is satisfied. In one embodiment, a loan status of “active” corresponds to a situation in which the lender indicates that the loan has not yet been paid in full or that the borrower has otherwise not yet satisfied their obligation under the loan.

Another example triggering condition 48 that the process can detect at block 64 is where one or more pre-determined patterns 49 of transactions or transaction types exist in a transaction history associated with the property. The pre-determined patterns are correlated to an increased risk of fraud associated with a reported transaction for the property. One such case is where at least one pattern 49 in the transaction history indicates that a lien has been released on a property without the property being secured by another lien beforehand. A process for detecting pre-defined patterns 49 in the transaction history is described in Section III with respect to FIG. 3, and this process is compatible with the process described with respect to FIG. 2 for determining whether the pattern exists and the triggering condition is satisfied.

A further example fraud risk trigger 48 that the process can detect at block 64 is the reporting of an assignment of an interest in a property (e.g., mortgage or other lien) that has a relatively high likelihood of being fraudulent. The assignment may be publicly recorded or reported in some other fashion. The trigger condition may be satisfied by a reported assignment to an entity that is not included in a list of pre-qualified assignees 47, for example. In one case, the list of pre-qualified entities 47 includes one or more lenders or other financial institutions and the document is recorded describing an alleged assignment of a mortgage on a property to a private party not included in the list of pre-qualified entities 47. In some cases, the trigger condition is satisfied when an interest in the property is transferred to a first type of entity (e.g., a private party) or to an entity that is not of a particular pre-qualified type (e.g., not a lending institution). In another case, the trigger condition is satisfied when the transfer is from a first type of entity (e.g., a lending institution) to a second type of entity (e.g., a private party).

A fourth type of example trigger condition 48 that the process can check at block 64 is whether loan application activity for an individual or other entity that is attempting to borrow funds to finance a property indicates an elevated risk of fraud. For instance, a customer such as a mortgage lender may be considering whether or not to lend funds to the potential borrower. At block 64, the process can access the loan database 32 (e.g., a loan application consortium) to determine whether or not the potential borrower has other loan applications pending on other properties. In some embodiments, if the borrower has a pre-determined number of applications pending on other properties (e.g., 1, 2, 3, 4, 5 or more), the process determines that the triggering condition is met. While several example trigger conditions 48 have been described for the purposes of illustration, other compatible trigger conditions 48 are possible.

At block 66, the process determines a risk of fraud associated with the property or with a particular reported transaction associated with the property, based on the whether one or more of the trigger conditions 48 are met. The fraud risk can be represented in a variety of different manners, depending on the embodiment. For instance, the process may generate a binary indication (e.g., “low fraud risk”/“high fraud risk”, “transaction validated”/“transaction not validated”, “validated”/“not validated”, etc.), or may provide a score or some other more granular indication (e.g., “valid”, “very likely valid”, “likely valid”, “likely invalid”, “very likely invalid”, “invalid”). In such embodiments, the determination of the degree of fraud risk can be based on which type(s) of triggering condition(s) is satisfied and/or how many triggering conditions are satisfied.

In some cases, the system 20 can trigger human review (e.g., by employees of the analytics provider) of the associated document(s). For example, the system 20 may provide functionality allowing operators to assess/categorize the reason for a detected inconsistency (other trigger, or other determined indication of potential fraud). The customer interface 24 may display the relevant documents and/or corresponding identifiers and prompt the operator to categorize the inconsistency (e.g., fraud, data input error, recorded documentation error, etc.). Thus, the human review can inform the fraud-risk determination. For instance, detection one or more of the fraud risk triggers for a lien release may trigger human review of the lien release. If the review indicates that there was a data input error, for instance, the operator may enter a downwardly adjusted risk of fraud because the triggering condition may be due to the input error. Or the operator may enter the correct data and cause the system 20 to perform the fraud analysis process again using the correctly entered data. On the other hand, if the human review does not identify an adequate explanation for the inconsistency (or other trigger), or confirms that there is an elevated risk of fraud, the operator may leave the fraud risk determination unchanged, or enter an upwardly adjusted fraud risk.

### III. Assessing Fraud Risk by Analyzing the Property Transaction History (FIG. 3)

FIG. 3 illustrates an example process that can be used by the analytics system 20 of FIG. 1 to determine whether one or more pre-determined patterns exist in the property transaction history, where presence of a pattern indicates an elevated risk of fraud. The pattern detection can be performed by the pattern analyzer 46 of FIG. 1, for example. In some embodiments, the process is preferably used for processing publicly recorded lien release transactions, for example, and the process will be described with respect to this type of transaction, although the system 20 can detect patterns to determine fraud risk associated with other types of reported transactions (e.g., grant deeds, trust deeds, mortgages, etc.).

At block 70, the process accesses a property transaction history, from the aggregated property database 34, for example, or from another appropriate source.

At block 72 the process processes the transaction history to determine whether one or more pre-determined patterns 49 of transactions or transaction types exist in a transaction history. The pre-determined patterns are correlated to an increased risk of fraud associated with certain types of property-related transactions. For instance, an elevated risk of fraud can exist where a pattern of transactions indicates that there is a relatively high likelihood that the resulting encumbrance status of the property is inaccurate. One such case is where a pattern 49 in the transaction history indicates that a lien has been released where no further encumbrances exist on the property. For instance, a first lien (e.g., a deed of trust or mortgage) is recorded and then a lien release (e.g., a deed of release) is recorded for the first lien at some later point in time, where no intervening lien was recorded between the recording of the first lien and the recording of the release. In some cases, the patterns 49 can be based on loan payment information. For instance, a particular pattern 49 may indicate an elevated risk of fraud where a loan is reportedly paid in full or otherwise satisfied within a certain period of time prior to the loan term. As just one example, where a 30 year loan is paid off in 4 years or less, such a pattern 49 may correspond to a relatively high fraud risk (e.g., “highly suspicious”). If the same loan is paid off from between 4 years and 10 years into the loan, the pattern 49 may indicate a moderate risk of fraud (e.g., “somewhat suspicious”). If the loan is paid off more than 10 years into the loan, the fraud risk may be relatively low (e.g., “not suspicious”). This and other patterns 49 can in some cases also be present in non-fraudulent scenarios. For instance, the example pattern can occur where a home owner pays off their mortgage and does not take out a new mortgage. However, the pattern 49 can nevertheless correspond to an increased likelihood that the recorded lien-release was fraudulent. For instance, it may be statistically relatively unlikely for homeowners to own their homes debt free, such as where the property is located in a relatively affluent geographic region where the average loan-to-value ratio is relatively high. Detection of a combination of different types of events in the transaction can indicate an elevated fraud risk. For instance, where a delinquency is detected and a lien-release is recorded (e.g., a lien release without an intervening mortgage), this can be indicative of an elevated fraud risk because it is unlikely that someone who is having trouble making regular payments would be able to satisfy their loan. Other types of information and data sources can be used. For instance, information received from a Multiple Listing Service (MLS) is used in the anomaly detection process. In one embodiment, for instance, the system consults an MLS to determine whether or not the property is listed as a short sale. If the property is listed as a short sale and there is a lien release (e.g., a lien release without an intervening mortgage), this can indicate an elevated risk of fraud.

Table 1 below provides an example of a portion of a transaction history including a recording of a lien release, but where a pre-determined pattern 49 is not present in the transaction history. Thus, there may be a relatively low risk of fraud associated with the lien release transaction. Table 2, on the other hand, provides an example of a portion of a transaction history in which a pre-determined pattern 49 of transactions does exist in association with a recorded lien release, and there is therefore an elevated risk of fraud associated with the lien release.

TABLE 1
Sample Transaction History Without Elevated Risk of Fraud

| | Date | | | Buyer/ | | | Orig. |
|---|---|---|---|---|---|---|---|
| | Recorded | Doc. Type | Doc. # | Borrower | Seller | Lender | Doc. # |
| 1 | Jan. 02, 2001 | Grant Deed | 12344 | John | Sally | | |
| 2 | Jan. 02, 2001 | Mortgage | 12345 | John | | ABC Bank | |
| 3 | Feb. 01, 2003 | Mortgage | 54321 | John | | XYZ Bank | |
| 4 | Mar. 15, 2003 | Deed of | 09876 | John | | | 12345 |
| | | Release | | | | | |

The portion of the transaction history shown in Table 1 is representative of a typical scenario where a buyer, John, is granted a mortgage loan by ABC Bank on a property that he is buying from a Sally. A Grant Deed transferring the property from Sally to John is recorded as document no. 12344. That same day, and usually recorded immediately after the deed (concurrently with) a mortgage lien is recorded as a document “12345”. John later decides to refinance his property, and is granted a mortgage loan from XYZ Bank to do so. The lien for the refinance mortgage is recorded as document no. 54321. After the Deed of Trust for the refinance mortgage is recorded, a Deed of Release is recorded (document no. 09876) releasing the first mortgage lien.

TABLE 2
Sample Transaction History With Pattern Indicating Elevated Risk of Fraud

| | Date | | | Buyer/ | | | Orig. |
|---|---|---|---|---|---|---|---|
| | Recorded | Doc. Type | Doc. # | Borrower | Seller | Lender | Doc. # |
| 1 | Jan. 02, 2001 | Grant Deed | 12344 | John | Sally | | |
| 2 | Jan. 02, 2001 | Mortgage | 12345 | John | | ABC Bank | |
| 3 | Jan. 01, 2003 | Deed of | 09876 | John | | | 12345 |
| | | Release | | | | | |
| 5 | Jan. 12, 2003 | Grant Deed | 23455 | Fred | John | | |
| 5 | Jan. 12, 2003 | Mortgage | 23456 | Fred | | XYZ Bank | |

The portion of the transaction history shown in Table 2 includes a pattern of transactions indicating an elevated risk of fraud. As in Table 1, a buyer, John, is granted a mortgage loan by ABC Bank on a property that he is buying from a Sally. A Grant Deed transferring the property from Sally to John is recorded as document no. 12344. That same day, and usually recorded immediately after the deed (concurrently with) a mortgage lien is recorded as a document “12345”. A Deed of Release is then recorded (document no. 09876) releasing the first mortgage lien. Fred agrees to buy the property from John and is granted a mortgage on the property by XYZ bank. A Grant Deed transferring title in the property from John to Fred is recorded (doc. no. 23455). On the next day, the second mortgage lien is recorded as document no. 23456.

In the portion of the transaction history depicted in Table 2, a first lien (document no. 12345) was recorded on the property, and a release of the lien (document no. 09876) was recorded prior to a subsequent lien being recorded on the property. This pattern of transactions is indicative of an elevated risk of fraud associated with the lien release.

At block 74 the process determines a risk of fraud associated with the lien release transaction based on the pattern detection processing performed in block 72. For instance, presence of one or more of the patterns 49, such as in the scenario depicted in Table 2, generally indicates an increased risk of fraud. The fraud risk can be represented in any desired manner, such as in a binary (e.g., “low risk” or “high risk”) fashion or instead in a more granular fashion, as discussed above in Section II. Moreover, where there are more than one distinct pattern 49, the degree of risk can be based on the number of patterns 49 detected at block 72, e.g., where a higher number of detected patterns correspond to higher degree of risk. Or, in some cases, the degree of risk can be based on which patterns 49 are detected, e.g., where certain patterns 49 are correlated to a higher degree of risk than other patterns 49.

At block 76, the process can output an indication of fraud risk. For instance, the process may generate a report indicating the results of the fraud risk determination (or an offer to provide such a report) and/or communicate the report to customers in any of the manners described herein, or in some other appropriate fashion.

Referring again to the example of Table 2, Table 2 depicts a scenario in which XYZ Bank grants a mortgage to a subsequent buyer, Fred. In such a case, XYZ Bank may be a customer of the analytics provider, and the process may therefore output a report to XYZ Bank indicating an elevated risk of fraud associated with the lien release. In response, XYZ Bank may perform an investigation in order to verify the validity of the lien-release. After being satisfied that Bank ABC did indeed release the initial mortgage lien on the property, XYZ Bank grants the mortgage to the new buyer, Fred. For instance, XYZ Bank may contact ABC Bank or otherwise confirm that John paid off the initial mortgage.

In another scenario, the lien-release depicted in Table 2 is fraudulent. For instance, John or someone associated with John generates and records a fraudulent lien release (document no. 09876), before John has satisfied his mortgage with ABC Bank. John then attempts to fraudulently sell the property to Fred. Where the process of FIG. 3 provides XYZ Bank with an indication as to the elevated risk of fraud associated with the lien release, XYZ Bank may decide not to grant the mortgage to Fred based on this information. Or, XYZ Bank can perform an investigation and, upon determining that the lien-release was indeed fraudulently recorded, then decide not to grant the mortgage to Fred.

If, on the other hand, XYZ Bank is not notified of the elevated risk of fraud, XYZ Bank may go ahead and grant the mortgage to Fred, despite the fact that ABC Bank's initial lien on the property remains in place. In such a case, ABC Bank's lien is senior to XYZ Bank's lien. When ABC Bank becomes aware of the fraudulent lien release and subsequent purchase by Fred, ABC Bank will likely enforce its senior interest. Thus, XYZ Bank may lose some or all of its interest in the property. Even if XYZ Bank is able to recover some of its losses in an action against John, XYZ Bank will incur significant legal fees and other expenses in the process. Thus, the process of FIG. 3 can significantly reduce the risk that lenders or other customers of the analytics system 20 will incur losses due to fraud.

The pre-defined patterns 49 can be identified and entered into the analytics system 20 in different ways. For instance, the patterns may be identified in a heuristic fashion, based on industry experience, and entered into the system 20 by an administrator or other appropriate individual. In some cases the customers provide the patterns 49 (e.g., using the interface 24). In some cases, the patterns 49 are determined dynamically and/or automatically utilizing historical property data. For instance, the system 20 may access transaction history data (e.g., from the aggregated property database 34) from a group of properties in which fraudulent transactions occurred, and identify patterns 49 those transaction histories share in common and that are correlated to an increased risk of fraud.

While in the described example the fraud risk determination is based on the dates of recordation for the recorded documents (e.g., the Grant Deed and the Deed of Release), in some embodiments, the dates that are used in the determination are instead the dates at which the respective transactions allegedly occurred, as indicated in the recorded documents.

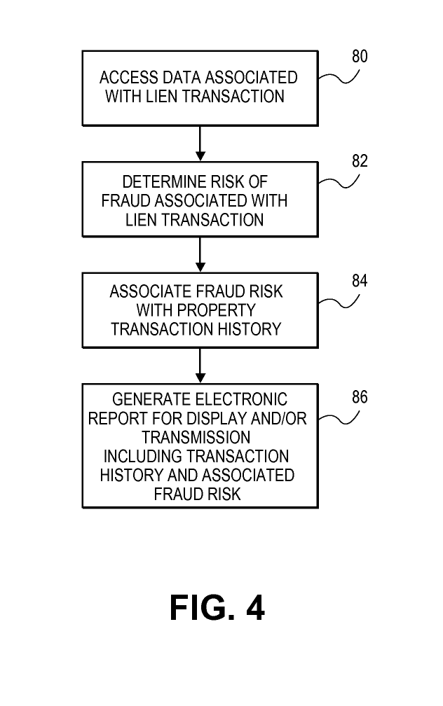

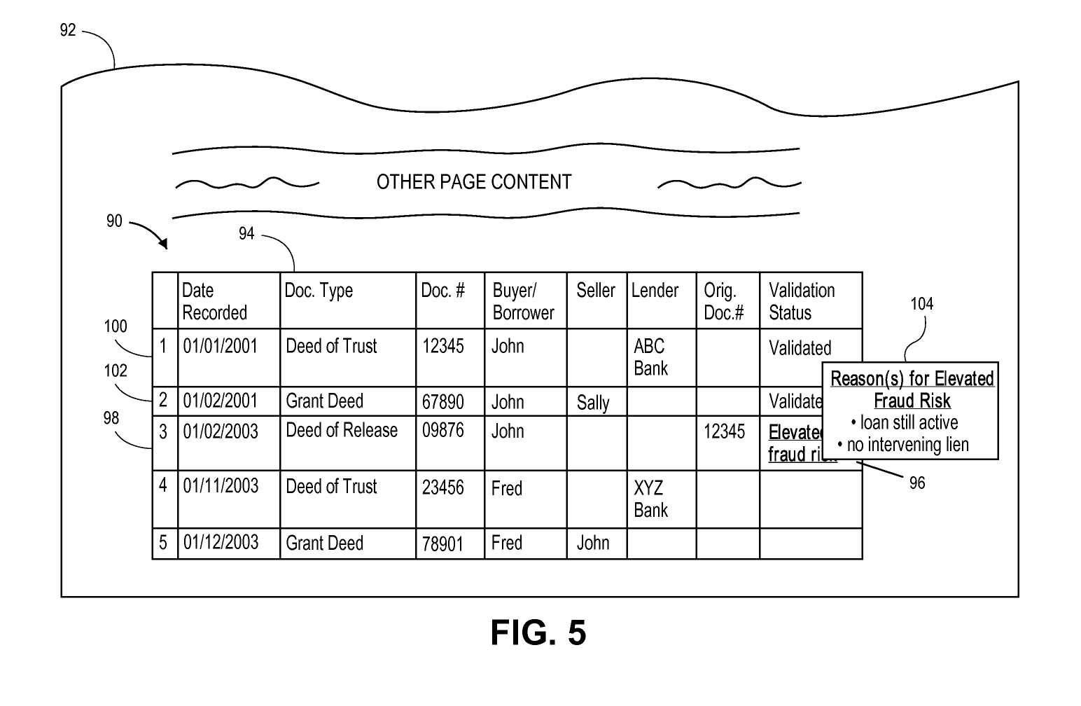

IV. Integrating a Lien Release Fraud Risk Indicator with a Property Transaction History (FIGS. 4 and 5)

FIG. 4 illustrates a sequence of steps performed by one embodiment of the analytics system 20 of FIG. 1 to integrate an indication as to a determined risk of fraud associated with a property transaction into a transaction history associated with the property.

At block 80, the process accesses data associated with a lien transaction. For instance, the process may access the loan data 32 or the aggregated property data 34, some other data source described herein, or another data source. The lien transaction may be a publicly recorded lien release, for example, or some other type of transaction (e.g., a publicly recorded deed of trust, grant deed or mortgage).

At block 82, the process determines a risk of fraud associated with the lien transaction. For instance, the process can use any of the techniques described herein to determine a risk of fraud associated with the lien transaction, such as the trigger-based risk assessment provided in Section II with respect to FIG. 2 and/or the transaction history pattern analysis provided in Section III with respect to FIG. 3.

The process at block 84 associates the determined fraud risk with a transaction history for the property. While generally any appropriate manner of association is possible, in one embodiment the transaction history is a record in the aggregated property database 34, and the determined fraud risk (or a pointer thereto) is added as an entry to the record.

At block 86, the process generates an electronic report for display including the transaction history and the associated fraud risk. For instance, the report may be generated using the reporting service 44 and provided for display through the customer interface 24, as described herein.

FIG. 5 illustrates a user interface 90 providing an example electronic report on a web page 92. The user interface 90 can be provided on a variety of different types of web pages of a web site or other interactive system. For example, this interface 90 may be provided on a transaction history portion of a web site, where the web site provides a comprehensive report for the property which can include details describing the property, images of the property, historical sale information, tax information, recent comparable sales, and the like. The report may be similar to those available from CoreLogic, Inc.'s RealQuest product. In some embodiments, the report can be XML based, or some other type of data transfer mechanism. In other embodiments, the user interface 90 is not included in a web page. For instance, in one embodiment, the user interface 90 is included in an email including the comprehensive property report.

As shown, the user interface 90 includes a transaction history section 94. The transaction history 94 includes an indicator 96 showing a determined fraud risk associated with a lien release transaction 98. As shown, the indicator 96 is preferably integrated with, embedded in, or otherwise visually associated with the entry of the corresponding transaction 98 in the displayed transaction history 94.

The nature of the indicator 96 can vary depending on the embodiment. While the depicted indicator 96 comprises text, the indicator 96 in some cases can include a graphic or icon (e.g., a check mark, thumbs-up symbol, thumbs-down symbol, empty set symbol, etc.) In some cases, instead of simply indicating whether or not there is an elevated risk of fraud associated with the transaction 98, the indicator 96 provides a more granular indication as to the degree of risk associated with the transaction (e.g., “low”, “medium”, or “high”). In another embodiment, the indicator 96 comprises a numerical or other code value, where each code value corresponds a particular risk of fraud. In some cases, the indicator provides a validation status (e.g., “validated”, “not validated”) associated with the transaction. In such cases, a “validated” transaction can indicate a nominal or relatively low risk of fraud. For instance, the first two transactions 100, 102 include respective indicators 104, 106 indicating that the transactions have been validated. In some cases, the indicator 96t or another icon provides a score (e.g., a number from 0-10) indicating the degree of fraud risk.

In addition, the user interface 90 can display information to the user describing one or more bases for the determined risk of fraud. For instance, in the illustrated embodiment, there is an elevated risk of fraud associated with the lien release transaction 98, and the user interface 90 provides one or more reasons for the elevated fraud risk. Moreover, as shown, in some embodiments, the user can interact with the indicator 96 to reveal the reason(s). In the illustrated example, for instance, the user clicks on the indicator to invoke a “pop-over” window providing two reasons for the elevated fraud risk—(1) that a loan corresponding to the allegedly released lien is still active, and (2) that there was no intervening lien recorded on the property after the recording of the initial lien and prior to the alleged release of the initial lien. The system can provide additional types of information in response to a user clicking on or otherwise selecting the indicator 96. For instance, an explanation of the logic used in determining the level of fraud risk can be displayed. In some embodiments, links to the publicly recorded documents (e.g., mortgage(s), lien release(s), etc.) used in the fraud risk determination are provided.

In some other embodiments, the user interface 90 does not initially provide the indicator 96 showing the fraud risk or validation status associated with the lien transaction(s). Instead, the user interface 90 provides a link or other item the user can interact with to purchase or otherwise access the fraud risk report. As just a couple examples, the user interface can initially provide a link associated with the transaction having a label similar to the following—“Purchase Fraud Risk Assessment for this Transaction?” or “Validate this Transaction?”. In addition, a message could be sent via email, text message or other mechanism reporting the elevated risk of fraud.

All of the methods and tasks described above may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other computer-readable storage medium. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

For example, the functional components 24, 22, 44, 42, 46 shown in FIG. 1 may be implemented by a programmed computer system (e.g., the server(s) 25) that comprises one or more physical computers or computing devices. Different components may, but need not, be implemented on or by different machines. The various data repositories 32, 34 shown in FIG. 1 or otherwise described may be implemented as databases, flat files, and/or any other type of computer-based storage system. The program logic illustrated in FIGS. 2-4 may be embodied in code that is executed by one or more computing devices of the computer system. The executable code may be stored on one or more computer storage devices or media.

Although this invention has been described in terms of certain embodiments, other embodiments that are apparent to those of ordinary skill in the art, including embodiments which do not provide all of the benefits and features set forth herein, are also within the scope of this invention. Accordingly, the scope of the present invention is defined only by reference to the appended claims.

What is claimed is:

1. A system for processing a transaction history associated with a property to identify an elevated risk of fraud associated with an apparent release of a lien on the property, the system comprising:
a computer system comprising one or more computers, said computer system configured to at least:
access a data repository to obtain a transaction history associated with a property, the transaction history comprising a list of a plurality of transactions involving the property, at least one of the transactions comprising the release of a lien on the property;
process the transaction history to the determine whether the transaction history includes an instance of a pre-determined pattern of transactions indicative of an elevated risk of fraud associated with lien releases, the pre-determined pattern of transactions comprises recordation of the lien and recordation of the release of the lien some time after the recording of the lien and without recordation of an intervening lien between the recordation of the release of the lien and the recordation of the release of the lien; and
generate an indication of an elevated risk of fraud at least partly in response to determining that the transaction history includes an instance of the pre-determined pattern of transactions.

2. The system of claim 1, wherein the pre-determined pattern of transactions comprises a pattern in which no other liens are secured by the property at the time of the lien release.

3. A system for processing a transaction history associated with a property to identify an elevated risk of fraud associated with an apparent release of a lien on the property, the system comprising:
a computer system comprising one or more computers, said computer system configured to at least:
access a data repository to obtain a transaction history associated with a property, the transaction history comprising a list of a plurality of transactions involving the property, at least one of the transactions comprising the release of a lien on the property;
process the transaction history to the determine whether the transaction history includes an instance of a pre-determined pattern of transactions indicative of an elevated risk of fraud associated with lien releases; and
generate an indication of an elevated risk of fraud at least partly in response to determining that the transaction history includes an instance of the pre-determined pattern of transactions.

4. The system of claim 3, wherein the pre-determined pattern of transactions comprises a pattern in which no other liens are secured by the property at the time of the lien release.

5. The system of claim 3, further comprising, in response to identifying the elevated level of risk, accessing a recorded document corresponding to the release of the lien.

6. The system of claim 3, further comprising:
accessing a database to obtain a record corresponding to the property;
processing the record to determine whether or not a loan associated with the lien is active; and
wherein said generating comprises generating the indication of the elevated risk of fraud in response to determining that the transaction history includes an instance of the pre-determined pattern of transactions, that the loan associated with the lien is active, or both.

7. The system of claim 3, wherein said generating comprises generating the indication of the elevated risk of fraud for display on a user interface along with the transaction history, wherein the indication is visually associated with an entry corresponding to the lien release in the displayed transaction history.

8. The system of claim 7, wherein a user can interact with the displayed indication in the user interface to reveal one or more reasons for the determination of the elevated risk of fraud associated with the lien release.

9. The system of claim 3, further comprising receiving an indication that the release of the lien was recorded, wherein said accessing step is automatically performed in response to said receiving.

10. A system for automatically identifying a potentially fraudulent transaction associated with a lien on a property, the system comprising:
a computer system comprising one or more computers, said computer system configured to at least:
receive an indication that a transaction associated with a lien on a property has occurred, the transaction comprising a publicly recorded release of the lien;
access data related to the property from one or more databases; and
analyze the data by a computer system that comprises one or more computers to determine whether one or more trigger conditions are met, each of the trigger conditions corresponding to an elevated risk of fraud associated with the lien transaction; and
in response to a trigger condition being met, provide an indication of the elevated risk of fraud associated with the lien transaction.

11. The system of claim 10, wherein the computer system analyzes the data by at least:
accessing a status of a loan associated with the lien from a database; and
determining that a trigger condition is met when the status indicates that the loan is still active.

12. The system of claim 10, wherein the computer system analyzes the data by at least:
accessing a transaction history including at least a sequential listing of a plurality of documents that have been recorded with respect to the property;
processing the transaction history to determine whether a pre-determined pattern exists in the transaction history which indicate an elevated risk of fraud associated with the lien transaction; and
determining that a trigger condition is met in response to determining that the pre-determined pattern exists in the transaction history.

13. The system of claim 12, wherein the one or more patterns include a recordation of the lien and a recordation of the release of the lien at some point after the recording of the lien, without a recordation of another lien on the property between recordation of lien and the recordation of the release of the first lien.

14. The system of claim 10, wherein the computer system analyzes the data by at least:
in response to an indication that the lien has been assigned to a first entity, accessing a data repository to obtain a list of pre-qualified entities;
comparing the first entity to the list; and
determining that a trigger condition is met when the comparison indicates that the first entity is not one of the pre-qualified entities.

15. The system of claim 10, wherein the computer system provides the indication by at least displaying an indication of the identified elevated risk of fraud along with an electronically accessible transaction history associated with the property.

16. The system of claim 10, wherein the computer system provides the indication by at least electronically communicating an indication of the identified elevated risk of fraud to one or more of a holder of the lien or to a lender who is considering whether or not to grant a loan on the property.

17. A system for providing an indication as to the validity of a recorded release of a lien on a property, the system comprising:
a computer system comprising one or more computers, said computer system configure to at least:
access, from one or more data repositories, data associated with the release of a lien on a property;
based at least on the data, determine a fraud risk associated with the release of the lien;
associate the determined fraud risk with a transaction history corresponding to the property, the transaction history maintained in computer storage and including a list of a plurality of events associated with the property, the plurality of events including the release of the lien; and
generate a signal indicative of said fraud risk and that is used to generate an electronic report that includes the transaction history and said fraud risk, the electronic report being accessible for display on a user computing device within a page that includes identifiers corresponding to at least some of the plurality of events of the transaction history and includes an identifier corresponding to the determined fraud risk.

18. The system of claim 17, wherein an identifier corresponding to the release of the lien is visually associated on the display with the identifier corresponding to the determined fraud risk.

19. The system of claim 17, wherein the computer system is further configured to associate an indication as to at least one basis for the determined fraud risk with the transaction history.

20. The system of claim 19, wherein the indication as to the at least one basis is displayed on the page in response to user interaction with the page.

21. The system of claim 20, wherein the indication as to the at least one basis is displayed on the page in response to user interaction with one or more of the identifier corresponding to the release of the lien and the identifier corresponding to the determined fraud risk.

22. The system of claim 19, wherein the at least one basis comprises a loan associated with the lien still being in an active state after the release of the lien.

23. The system of claim 19, wherein the at least one basis comprises an inclusion in the transaction history of a recording of the release of the lien without another lien being secured by the property at the time the release of the lien was recorded.
